(19) United States
(12) Patent Application Publication
(10) Pub. No.: US 2009/0278437 A1
(43) Pub. Date: Nov. 12, 2009

(54) PLASMA LIGHT EMITTING STRING, AND PLASMA LIGHT EMITTING STRING DISPLAY DEVICE EMPLOYING SUCH PLASMA LIGHT EMITTING STRINGS

(75) Inventors: Yosuke Yamazaki, Hyogo (JP); Kenji Awamoto, Hyogo (JP)

Correspondence Address: STITES & HARBISON PLLC, 401 COMMERCE STREET, SUITE 800, NASHVILLE, TN, 37219, US

(73) Assignee: Shinoda Plasma Corporation, Hyogo (JP)

(21) Appl. No.: 12/297,177

(22) PCT Filed: Apr. 14, 2006
(86) PCT No.: PCT/JP2006/307930

§ 371 Date: Oct. 14, 2008

(51) Int. Cl. H01J 63/04

(52) U.S. Cl. 313/485

(57) ABSTRACT

A light emitting string is produced by forming a fluorescent layer on a fluorescent layer support member having an opening and configured such as to protect the fluorescent layer, and inserting the fluorescent layer support member into a minute tube. Therefore, when the fluorescent layer support member is inserted into the minute tube, the fluorescent layer is prevented from contacting the interior wall of the minute tube. This prevents the chipping, the separation and the cracking of the fluorescent layer, thereby improving the yield in production of plasma light emitting strings.

### TECHNICAL FIELD

The present invention relates to a plasma light emitting string, and a display device employing such light emitting strings. More specifically, the invention relates to a light emitting string having a discharge space in which a discharge gas and a fluorescent material are sealed, and to a plasma light emitting string display device having a display screen including a plurality of arrayed light emitting strings.

### BACKGROUND ART

Display devices including a multiplicity of arrayed light emitting tubes utilizing the principle of plasma display are disclosed in JP-A-2003-286043, JP-A-2005-129357 and JP-A-2005-191016 to provide large-scale image display apparatuses having a self-luminous property.

Further, a method of producing an elongated hollow minute tube having an elliptical cross section from a cylindrical glass tube is disclosed in JP-A-2003-286043. When a fluorescent layer is formed in the elongated hollow minute tube, a fluorescent paste is injected into the tube, and dried and fired with the longitudinal axis of the tube kept horizontally. With this method, however, it is difficult to form the fluorescent layer to an even thickness throughout the entire length thereof. Further, a binder contained in the paste is liable to adhere to an interior wall of the tube. This may result in deterioration of color purity when light is emitted from the fluorescent layer. Since a glass tube is typically used as the elongated tube, the tube is less liable to fracture even if being significantly deformed. However, the fluorescent layer formed on the interior wall of the glass tube is fragile and, therefore, is liable to be partly cracked or separated from the interior wall of the tube when the glass tube is flexed.

To overcome these drawbacks, JP-A-2005-191016 discloses a method for providing a fluorescent layer in an elongated minute tube having an inner diameter of 0.8 mm and a round cross section by inserting a support member formed with the fluorescent layer into the minute tube, and a light emitter including an elongated planar support member or a support member curved to fit on an elongated tube. Further, JP-A-2005-129357 discloses a method in which a fluorescent layer is formed on a concave surface portion of a generally crescent-shaped fluorescent layer support member, and the fluorescent layer support member formed with the fluorescent layer is placed in an elongated tube having a generally rectangular cross section.

### Patent Document 1: JP-A-2003-286043

### Patent Document 2: JP-A-2005-129357

### Patent Document 3: JP-A-2005-191016

### DISCLOSURE OF THE INVENTION

### Problems to be Solved by the Invention

The inventor of the present invention prepared light emitting tubes by using fluorescent layer support members each having the same shape as that disclosed in the aforementioned patent document, and produced a display device by arraying the light emitting tubes, and bonding plates respectively formed with sets of electrodes to front and rear sides of the array of the light emitting tubes. However, the inventor found that the display device employing the fluorescent layer support members suffered from uneven light emission in each light emitting tube, and that some of the light emitting tubes suffered from uneven light emission during prolonged operation of the display device though being initially free from the uneven light emission. To solve this problem, the inventor conducted intensive studies, and found that some of the light emitting tubes employing the prior-art fluorescent layer support members suffered from the following phenomena with the possibility of the separation of the fluorescent layers from the fluorescent layer support members.

One reason for the separation of the fluorescent layers will be described with reference to FIG. 1. FIG. 1A illustrates a minute glass tube 10 in which a fluorescent layer support member 14 formed with a fluorescent layer 12 is inserted and a discharge gas 20 is filled. The fluorescent layer support member 14 is configured as having an opening extending longitudinally of the minute glass tube 10. The fluorescent layer support member 14 has a sectional shape such that a distance between side surfaces thereof gradually increases in a direction from a bottom to the opening thereof. In order to increase the light intensity, a fluorescent material is applied to the widest possible area of the fluorescent layer support member 14, so that the fluorescent layer is formed as extending to edges of the fluorescent layer support member 14.

FIG. 1B is a diagram illustrating a portion circled by a one-dot-and-dash line in FIG. 1A on an enlarged scale. When the fluorescent layer support member 14 is squeezed into the minute glass tube 10, an edge 18 of the fluorescent layer 12 is liable to contact a protuberance 16 formed on an interior wall of the minute glass tube 10 during production of the minute glass tube 10. The contact may result in chipping of the edge 18 or cracking of the fluorescent layer 12. The chipping of the fluorescent layer 12 reduces the luminous intensity at a chipped portion of the fluorescent layer 12. Further, the cracking is aggravated by vibrations of the light emitting tube and the fluorescent layer support member during prolonged driving of the light emitting tube, thereby resulting in separation of the fluorescent layer 12. This also reduces the luminous intensity at a cracked portion of the fluorescent layer 12. Thus, problems associated with the use of the prior-art fluorescent layer support member are identified.

It is therefore an object of the present invention to provide a plasma light emitting string which is arranged to prevent damage of a fluorescent layer which may otherwise occur when a fluorescent layer support member formed with the fluorescent layer is inserted into a minute tube longitudinally of the minute tube, and to provide a display device employing such plasma light emitting strings.

### Means for Solving the Problems

According to one aspect of the present invention to solve the aforementioned problems, there is provided a plasma light emitting string, which includes: an elongated tube made of a light transmissive material; a fluorescent layer support member formed with a fluorescent layer and disposed in the elongated tube; and a discharge gas filled in the elongated tube; wherein a width of an opening of the fluorescent layer support member defined between ends of an outer peripheral portion of the fluorescent layer support member as seen in a section taken perpendicularly to a length of the fluorescent layer support member is smaller than a maximum width of the outer peripheral portion of the fluorescent layer support member. A portion of the fluorescent layer support member adjacent to the opening preferably has a thickness that is smaller than a maximum thickness of the fluorescent layer support member. Further, the fluorescent layer support member preferably includes bulges provided along the edges. Here, the bulges each have a generally round cross section or an elliptical cross section.

According to another aspect of the present invention, there is provided a light emitting string display device, which includes: a plurality of plasma light emitting strings arrayed with their openings facing in the same direction, the plasma light emitting strings each being the aforementioned plasma light emitting string; a front plate opposed to the openings of the plasma light emitting strings; a rear plate opposed to the front plate with the intervention of the plasma light emitting strings; a plurality of sustain electrodes provided on a surface of the front plate contacting the plasma light emitting strings as extending perpendicularly to lengths of the plasma light emitting strings; and a plurality of address electrodes provided in association with the corresponding plasma light emitting strings on a surface of the rear plate contacting the plasma light emitting strings as extending perpendicularly to the sustain electrodes.

### Effects of the Invention

In the inventive plasma light emitting string, the width of the opening of the fluorescent layer support member is smaller than the width of the fluorescent layer support member. Therefore, when the fluorescent layer support member is inserted into the elongated tube, side surfaces of the fluorescent layer support member are brought into contact with an interior wall of the tube. Since the fluorescent layer does not contact the interior wall of the tube, the fluorescent layer is less susceptible to damage and, hence, the plasma light emitting string emits light substantially free from unevenness in color. Further, the plasma light emitting string is less liable to suffer from cracking and other damages. Therefore, even if vibrations occur in the plasma light emitting string during the light emission from the plasma light emitting string, the separation of the fluorescent layer is suppressed. Since the interior wall of the tube and the fluorescent layer support member to be brought into contact with each other are both curved, the fluorescent layer support member can be smoothly inserted into the tube. This suppresses damage of the tube or the fluorescent layer support member, and improves the working efficiency.

### BRIEF DESCRIPTION OF THE DRAWINGS

FIG. 1 is a schematic diagram for explaining problems associated with a prior-art plasma light emitting string.

FIG. 2 is a diagram schematically illustrating a plasma light emitting string display device including a plurality of arrayed plasma light emitting strings, and a front plate and a rear plate respectively disposed on a front side and a rear side of the array of the plasma light emitting strings.

FIG. 3 is a schematic diagram showing a method of producing a fluorescent layer support member and a plasma light emitting string according to the present invention.

FIG. 4 is a schematic diagram showing another method of producing a fluorescent layer support member and a plasma light emitting string according to the present invention.

FIG. 5A is a schematic diagram showing the sectional shape of another fluorescent layer support member according to the present invention, and FIG. 5B is a perspective view of the fluorescent layer support member shown in FIG. 5A.

FIG. 6 is a schematic diagram showing the sectional shape of further another fluorescent layer support member according to the present invention.

FIG. 7 is a schematic diagram showing the sectional shape of still another fluorescent layer support member according to the present invention.

FIG. 8 is a schematic diagram showing the sectional shape of further another fluorescent layer support member according to the present invention.

FIG. 9 is a schematic diagram showing the sectional shape of still another fluorescent layer support member according to the present invention.

FIG. 10 is a schematic diagram showing the overall shape of the fluorescent layer support member according to the present invention.

FIG. 11 is a schematic diagram showing the overall shape of further another fluorescent layer support member according to the present invention.

FIG. 12 is a schematic diagram showing the step of applying a fluorescent material on fluorescent layer support members according to the present invention.

FIG. 13 is a schematic diagram showing the step of forming fluorescent layers with the use of a dispenser according to the present invention.

FIG. 14 is a perspective view showing the step of forming the fluorescent layers shown in FIG. 13 with the use of the dispenser.

FIG. 15 is a schematic diagram illustrating the fluorescent layer support member formed with the fluorescent layer.

FIG. 16 is a schematic diagram showing the step of inserting the fluorescent layer support member formed with the fluorescent layer into the minute tube according to the present invention.

FIG. 17 is a block diagram showing major circuits of the plasma light emitting string display device employing the plasma light emitting strings according to the present invention.

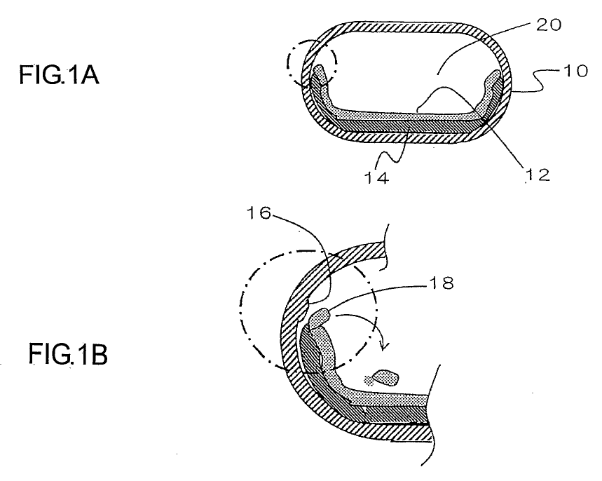

### BEST MODE FOR CARRYING OUT THE INVENTION

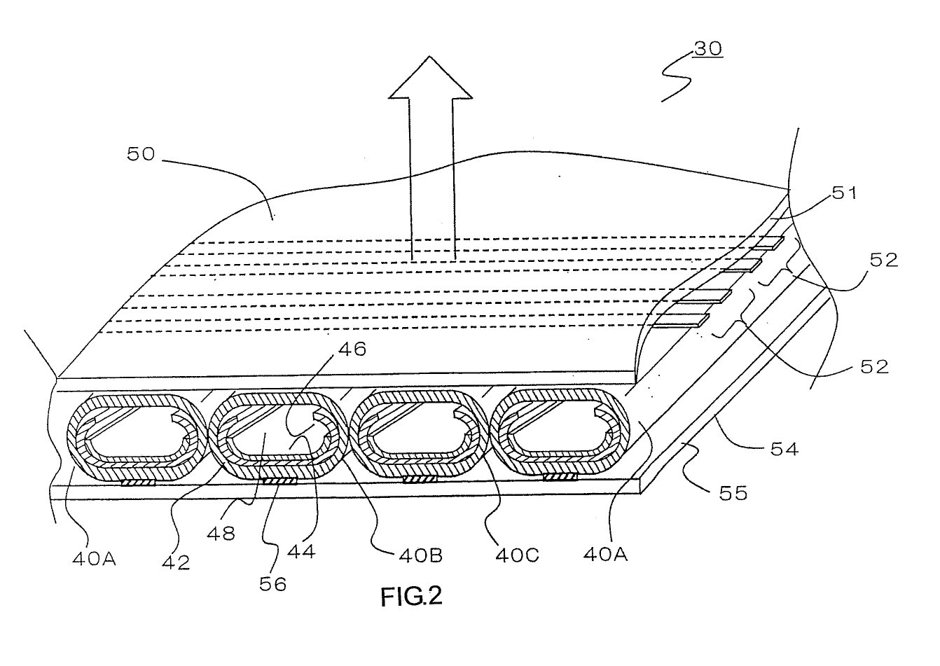

A preferred embodiment of the present invention will hereinafter be described with reference to FIG. 2. In this embodiment, a plasma light emitting string display device 30 employing plasma light emitting strings according to the present invention is adapted for full-color display, but may be adapted for monochrome display. If it is necessary to discriminate between the plasma light emitting strings by their light emission colors, the plasma light emitting strings are each designated “light emitting string 40A” “light emitting string 40B” or “light emitting string 40C” and, if there is no need to discriminate between the plasma light emitting strings, the plasma light emitting strings are each designated “light emitting string 40” without the alphabetic suffix. The light emitting strings each include an outermost portion which is referred to as “minute tube”. In this embodiment, the minute tube has a generally rectangular cross section (having a major axis length of 1 mm, a minor axis length of 0.5 mm and a wall thickness of 100 μm) as taken perpendicularly to the length thereof, and includes generally semicylindrical portions transversely opposed to each other and linear portions vertically opposed to each other. Alternatively, the minute tube may have a round cross section, an elliptical cross section, a trapezoidal cross section or a cross section having a projection or an indentation. Where the minute tube has a generally rectangular cross section, the dimensions of the tube are not limited to those described above.

FIG. 2 is a partial diagram illustrating major portions of the display device employing the plasma light emitting strings according to the present invention. Referring to this figure, the plasma light emitting string display device 30 will be described in greater detail. The light emitting strings 40 each include a fluorescent layer 44 provided on a fluorescent layer support member 46. More specifically, the light emitting string 40 includes a fluorescent layer 44 which emits red light, and the light emitting string 40B includes a fluorescent layer 44 which emits green light. Further, the light emitting string 40C includes a fluorescent layer 44 which emits blue light. The light emitting strings 40A, 40B, 40C are consecutively arrayed parallel to each other. A front film board 50 is bonded to a front side of the array of the light emitting strings 40 from which light is emitted (in an arrow direction in this figure), and a rear board 54 is bonded to a rear side of the array of the light emitting strings 40. The front film board 50 includes a base film 51, and a plurality of sustain electrode pairs 52 each including two electrodes and provided on a surface of the base film 51 contacting the light emitting strings 40 as extending perpendicularly to the lengths of the light emitting strings 40. The rear board 54 includes a base film 55, and address electrodes 56 provided in association with the corresponding light emitting strings 40 on a surface of the base film 55 contacting the light emitting strings 40 as extending parallel to the lengths of the light emitting strings 40.

A transparent adhesive is used for the bonding of the front film board 50 so that the light emitted from the light emitting strings 40 easily passes through the front film board 50. Preferred examples of the adhesive include epoxy resins and photo-curable resins. The base film 51 is a transparent film which transmits the light emitted from the light emitting strings 40. In this embodiment, a polyethylene terephthalate (PET) film having a thickness of 120 μm is used as the base film 51. The material for the base film 51 is not limited to PET, but any soft and transparent material may be used which ensures easy bonding of the base film 51 to the array of the light emitting strings 40 and permits formation of transparent electrodes (such as of an ITO film or an NESA film) as parts of the sustain electrode pairs 52 on the base film 51. Bus electrodes each made of a metal film (such as of copper, silver or gold) are respectively provided on the transparent electrodes. In this embodiment, the pitch of the sustain electrode pairs 52 is 3 mm. The transparent electrodes each have a width of 1 mm. The bus electrodes are each made of copper, and have a width of 50 μm. The sustain electrodes of each of the sustain electrode pairs are spaced 0.4 mm from each other. Therefore, adjacent ones of the display electrode pairs 52 are spaced 0.6 mm. The transparent electrodes each have a thickness of about 0.3 μm, and the bus electrodes each have a thickness of 10 μm. The bus electrodes may have a width W2 of 50 μm to 100 μm, and a thickness of 10 μm to 20 μm.

The base film 55 of the rear board 54 may be made of the same material as the front film board 50. The rear board 54 may be made of a material impervious to light and, for example, a glass substrate or a substrate made of a rigid resin material containing a black pigment or the like may be used as the base film 55. In this embodiment, the address electrodes 56 are formed as each having a width of 200 μm and a thickness of 20 μm by copper plating. The formation of the address electrodes 56 may be achieved by a printing method using an electrically conductive paste or by bonding a metal film such as a copper foil onto the base film 55 and etching the metal film into a desired pattern rather than by employing the plating method.

The light emitting strings 40 each include the minute tube 42, a protective film (not shown) formed on an interior wall of the minute tube, the fluorescent layer support member 46 formed with the fluorescent layer 44, and a discharge gas 48. In the light emitting string, the fluorescent layer support member 46 is fixed to the minute tube 42 by fusion-bonding longitudinally opposite ends of the minute tube 42 to the fluorescent layer support member 46. Since the plasma light emitting string display device 30 according to this embodiment is adapted for the full-color display, the fluorescent layers 44 formed on the fluorescent layer support members 46 of the light emitting strings 40A, 40B and 40C are adapted to emit red light, green light and blue light, respectively. These light emitting strings 40A, 40B, 40C are consecutively arrayed. The fluorescent layer support members 46 each have an opening opposed to the sustain electrode pairs 52, and the light emitting strings 40 are each adapted to emit light in the direction shown in the figure.

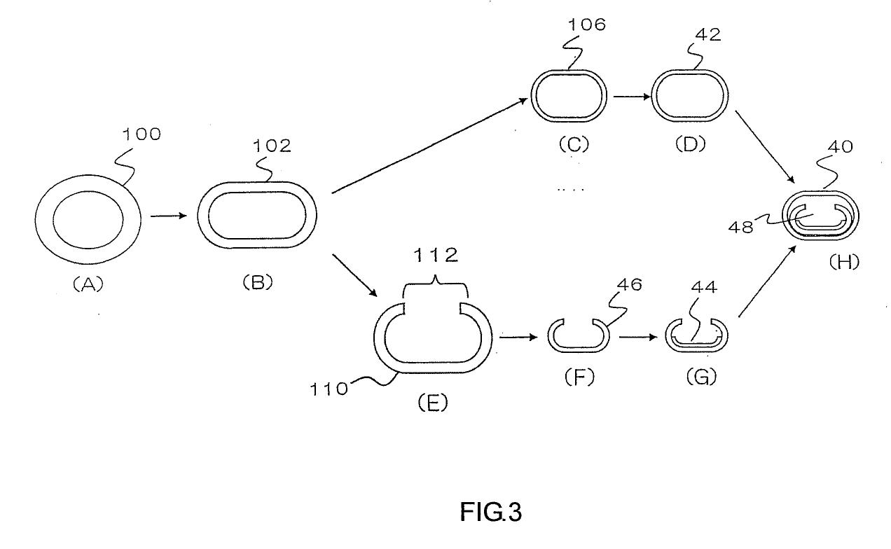

Next, a method of producing the light emitting string 40 will be described with reference to FIG. 3. FIG. 3 is a diagram showing a method of producing the light emitting string 46 from a cylindrical glass base material 100. In this figure, a production process for the minute tube 42 includes Steps (A)-(B)-(C)-(D), and a production process for the fluorescent layer support member 46 formed with the fluorescent layer 44 includes Steps (A)-(B)-(E)-(F)-(G). The light emitting string 46 is completed in Step (H) of the production method.

Next, the respective steps will be described in detail. In this embodiment, the minute tube 42 and the fluorescent layer support member 46 are produced from the same base material 100, but may be produced from different base materials. For example, a glass base material containing a white pigment may be used for the fluorescent layer support member 46.

In Step (A) shown in FIG. 3, a generally cylindrical base material 100 of borosilicate glass is cleaned. In Step (B), the base material 100 is placed on a jig (not shown) having a sectional contour generally analogous to the sectional contours of the minute tube 42 and the fluorescent layer support member 46, and heated to be deformed into a base material 102 having a generally rectangular sectional contour.

The base material 102 is worked into a minute tube 106 by a redrawing method disclosed, for example, in JP-A-2003-28643. After the minute tube 106 is cleaned, an organic liquid magnesium salt is applied onto an interior surface of the minute tube 106, and pyrolyzed. Thus, a minute tube 42 formed with a protective film of magnesium is obtained.

For the production of the fluorescent layer support member 46 from the base material 102, on the other hand, a flat portion of the base material 102 is cut away by a diamond cutter or a silicon wafer cutting saw, whereby a base material 110 is obtained which has an opening 112 extending longitudinally of the base material 102. Thereafter, a fluorescent layer support member 46 having a sectional shape generally analogous to the base material 110 is obtained by the aforementioned redrawing method. After the fluorescent layer support member 46 is cleaned, a fluorescent paste is applied onto an interior wall of the fluorescent layer support member 46, and dried and fired. Thus, a fluorescent layer 44 is formed.

After the fluorescent layer support member 46 having the fluorescent layer 44 formed on the interior wall thereof is inserted into the minute tube 42 having the protective film formed on the interior surface thereof, the discharge gas 48 is filled in the minute tube 42, and opposite ends of the minute tube 42 are melted and sealed. Thus, the light emitting string 40 is obtained.

In the production method shown in FIG. 3, the minute tube 42 and the fluorescent layer support member 46 are produced from the same base material 102, but may be produced from base materials having different material qualities and different shapes.

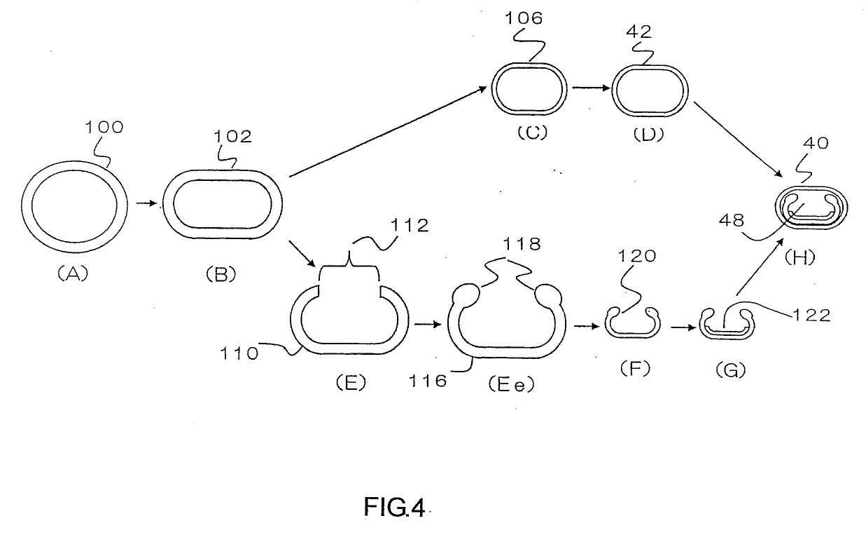

FIG. 4 shows a modification of the method of producing the light emitting string 40 shown in FIG. 3. The production method shown in FIG. 4 is different from the production method shown in FIG. 3 in that Step (Ee) is added. In Step (Ee), thicker wall portions are formed along edges of the opening 112 by partly heating the edges. The partial heating of the edges of the opening 112 is preferably achieved by laser irradiation. Alternatively, the partial heating for the formation of the thicker wall portions may be achieved by placing a heater longitudinally of the opening 112 and maintaining the edges at the softening temperature of the glass of the base material. After the formation of the thicker wall portions 118, a fluorescent layer support member 120 having bulges provided alongside the opening is produced by the redrawing method. Further, an etching method may be used for the formation of the bulges.

The base material 102 may have a generally rectangular sectional shape. Further, the fluorescent layer support member may be produced by cutting the base material 102 by means of the aforementioned diamond cutter to form the opening, and thermally deforming the edges of the base material 110 to provide the bulges.

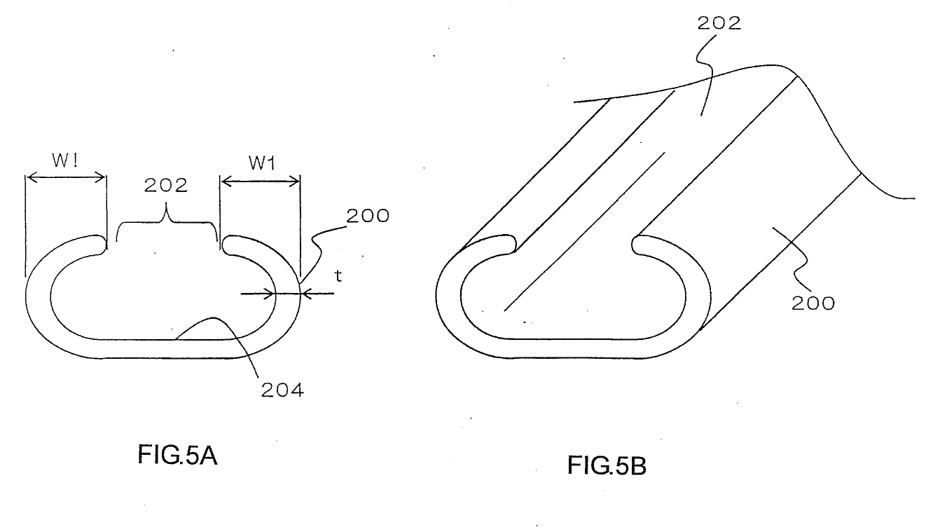

FIGS. 5 to 11 illustrate exemplary fluorescent layer support members having different sectional shapes.

A fluorescent layer support member 200 shown in FIG. 5A has a generally elliptical cross section having an opening 202 located on one side thereof. Edges of the opening 202 are each spaced from a laterally outermost portion of the fluorescent layer support member 200 by a distance W1 that is greater than the thickness t of the fluorescent layer support member 200. Thus, a fluorescent layer formed in the fluorescent layer support member 200 is protected by the edges of the opening 202. FIG. 5B is a perspective view of the fluorescent layer support member 200.

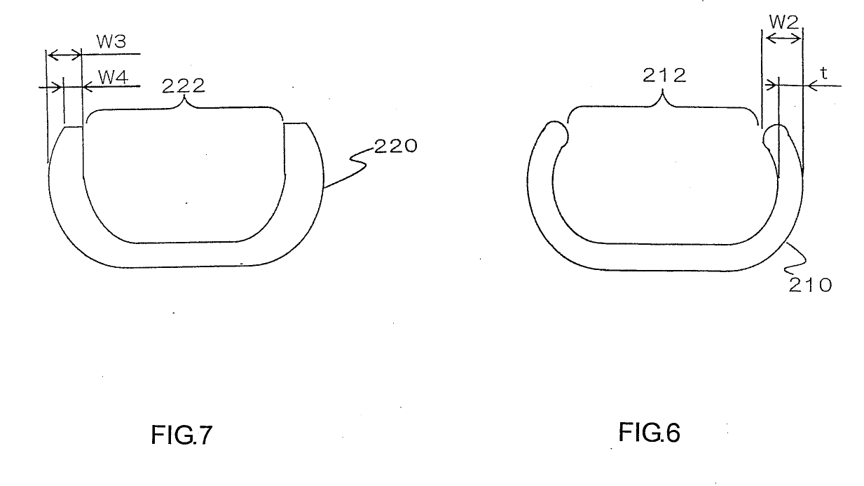

FIG. 6 shows the sectional shape of another fluorescent layer support member 210. The fluorescent layer support member 210 has an opening 212 which is wider than the opening 202 of the fluorescent layer support member 200 shown in FIG. 5A. Edges of the opening 212 of the fluorescent layer support member 210 are each spaced from a laterally outermost portion of the fluorescent layer support member 210 by a distance W2 that is greater than the thickness t of the fluorescent layer support member 210. The interior wall of the fluorescent layer support member 210 does not contact the minute tube 42 (see FIG. 2).

FIG. 7 is a diagram showing the sectional shape of further another fluorescent layer support member 220. Portions of the fluorescent layer support member 220 at edges of an opening 222 each have a thickness W4 that is smaller than the thickness W3 of a side wall of the fluorescent layer support member 220. Preferably, the side wall of the fluorescent layer support member 220 is generally perpendicular to a bottom of the fluorescent layer support member 220, so that the opening 222 has a greater width. Thus, light emitted from the fluorescent layer formed on the fluorescent layer support member 220 is less liable to be blocked.

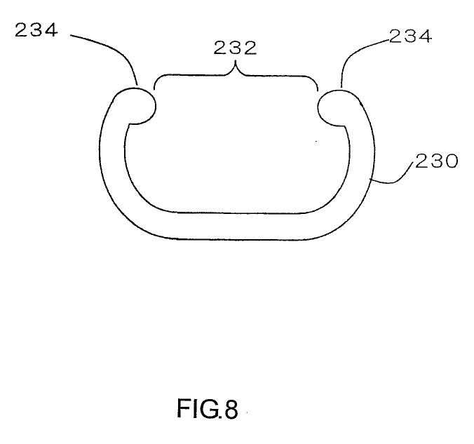

FIG. 8 is a diagram showing the sectional shape of still another fluorescent layer support member 230. The fluorescent layer support member 230 has bulges 234 respectively provided along opposite edges of an opening 232 thereof. With the provision of the bulges 234, the fluorescent layer support member 230 is less liable to be deformed due to contact between the minute tube 42 and the fluorescent layer support member 230 when the fluorescent layer support member 230 is inserted into the minute tube 42 (see FIG. 2). Further, friction occurring between the minute tube 42 and the fluorescent layer support member 230 is reduced.

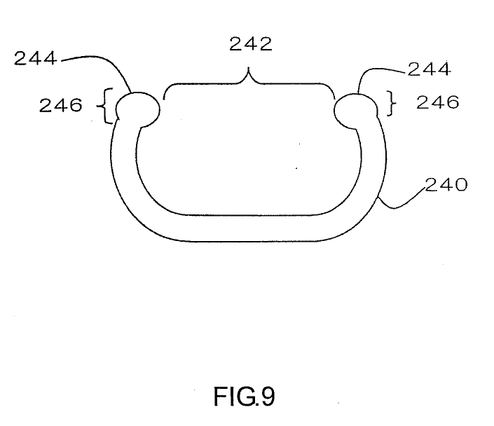

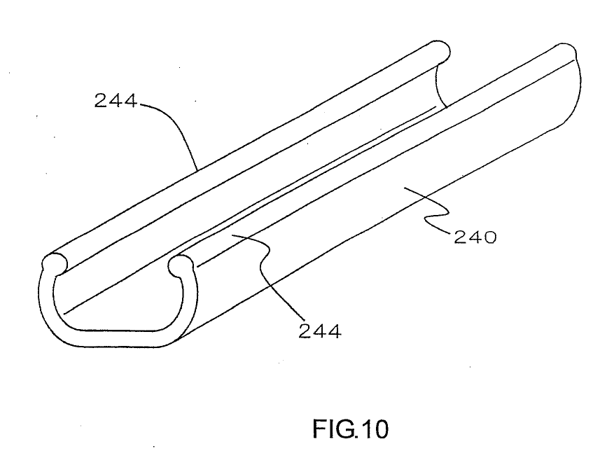

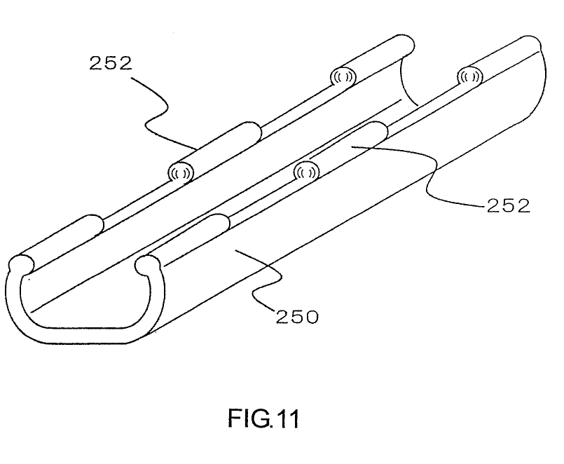

FIG. 9 is a diagram showing the sectional shape of further another fluorescent layer support member 240. The fluorescent layer support member 240 has bulges 244 respectively provided along opposite edges of an opening 242 thereof. The bulges 244 each have a portion 246 projecting outward from an outer peripheral surface of the fluorescent layer support member 240. With the provision of the projecting portion 246, friction caused by contact between the minute tube 42 and the fluorescent layer support member 240 is reduced when the fluorescent layer support member 240 is inserted into the minute tube 42 (see FIG. 2). This facilitates the insertion of the fluorescent layer support member 240 into the minute tube 42. The fluorescent layer support member 240 is shown in perspective in FIG. 10.

FIG. 11 illustrates a modification of the fluorescent layer support member 240 shown in FIG. 10. A fluorescent layer support member 250 has bulges 252, which are discontinuously provided longitudinally of the fluorescent layer support member 250. With this arrangement, the opening is only partly narrowed by the bulges 252, so that light emitted from the fluorescent layer formed on the fluorescent layer support member 250 is less liable to be blocked.

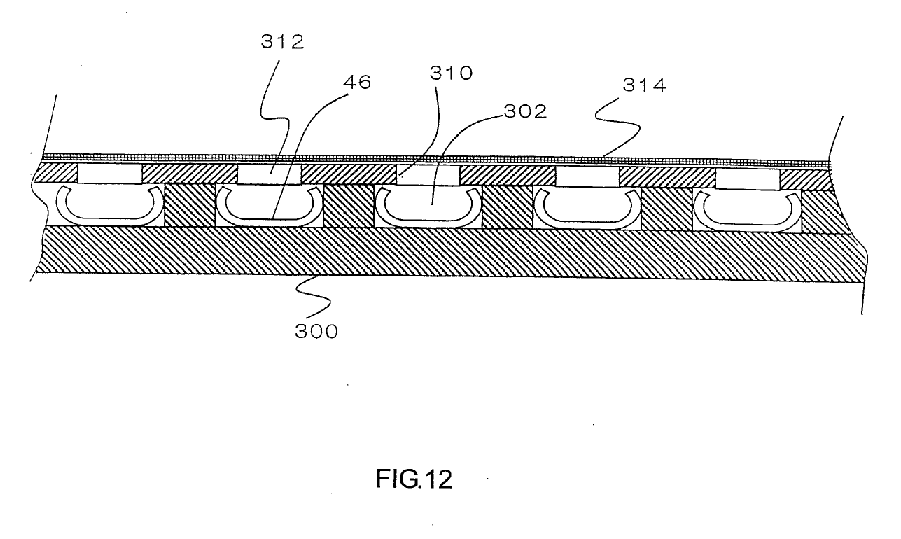

Next, methods for forming fluorescent layers on fluorescent layer support members will be described with reference to FIGS. 12 to 14. FIG. 12 shows how to form fluorescent layers on fluorescent layer support members 46. However, any of the aforementioned fluorescent layer support members may be used as the fluorescent layer support members.

As shown in FIG. 12, an application base 300 in which the fluorescent layer support members 46 are placed for positioning thereof has grooves 302 having substantially the same width and the same height as the fluorescent layer support members 46. The fluorescent layer support members 46 are respectively placed in the grooves 302. A frame 310 is fixed to the application base 300 with its openings 312 substantially aligning with center axes of the openings of the respective fluorescent layer support members 46 and extending longitudinally of the fluorescent layer support members 46. A squeezee 314 is placed on the frame 310, and a blade (not shown) is moved laterally of the figure or perpendicularly to the paper face of the figure, whereby a predetermined amount of a fluorescent material (not shown) spread over the squeezee 314 is applied onto the fluorescent layer support members 46.

Thereafter, the fluorescent material applied onto the fluorescent layer support members 46 are dried and fired. Thus, the fluorescent layer support members 46 respectively formed with the fluorescent layers 44 (see FIG. 2) are provided.

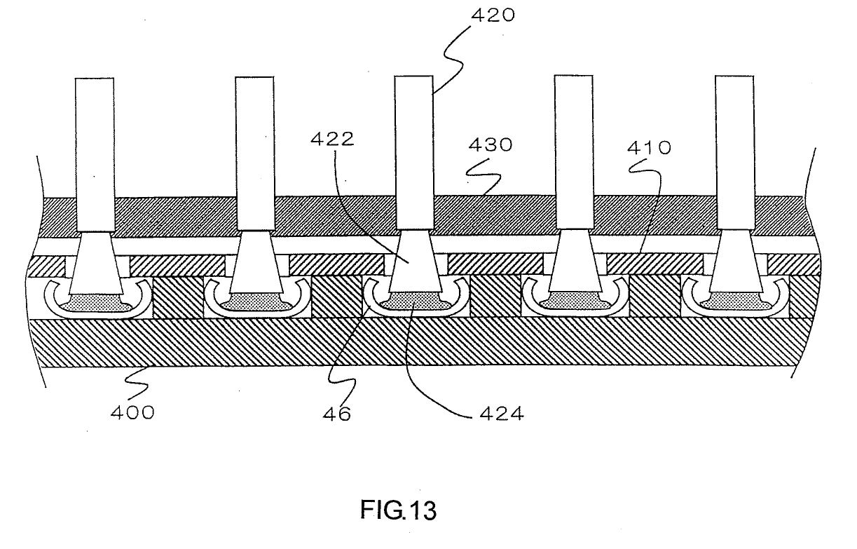

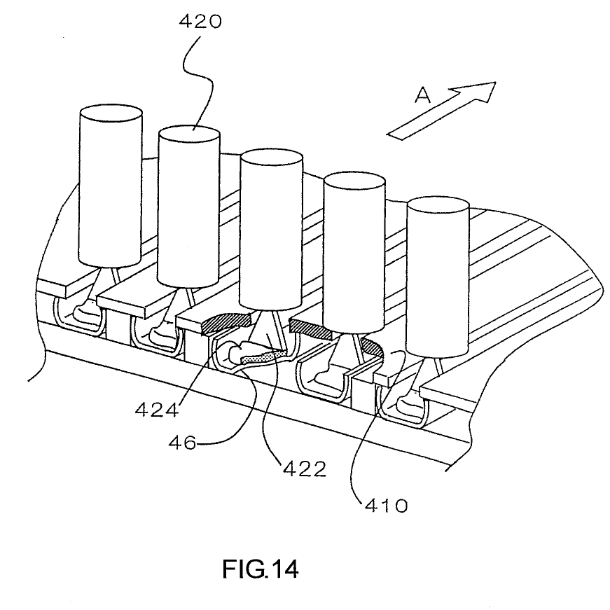

While the fluorescent material application method described above with reference to FIG. 12 uses the squeezee, the fluorescent material application method shown in FIGS. 13 and 14 uses a dispenser for applying the fluorescent material on the fluorescent layer support members 46. In FIG. 13, an application base 400 and a frame 410 respectively correspond to the application base 300 and the frame 310 shown in FIG. 12. As shown in FIG. 13, a fluorescent material paste is retained in tubes 420, and nozzles 422 are respectively provided at distal ends of the tubes 420. The nozzles 422 each have an expanded distal portion, from which the fluorescent material paste 424 is ejected onto the fluorescent layer support member 46. The tubes 420 are movable perpendicularly to the paper face of the figure by a tube holder 430. An arrangement for the application method shown in FIG. 13 is illustrated in perspective in FIG. 14. The tubes 420 are connected to a flexible tube not shown. A pressure is applied to the respective tubes 420 through the flexible tube. The amounts of the fluorescent material paste 424 to be applied onto the fluorescent layer support members 46 are determined by the pressure and the speed of the tubes 420 to be moved in an arrow direction A. Thereafter, the fluorescent material applied onto the fluorescent layer support members 46 is dried and fired. Thus, the fluorescent layer support members 46 respectively formed with the fluorescent layers 44 (see FIG. 2) are obtained.

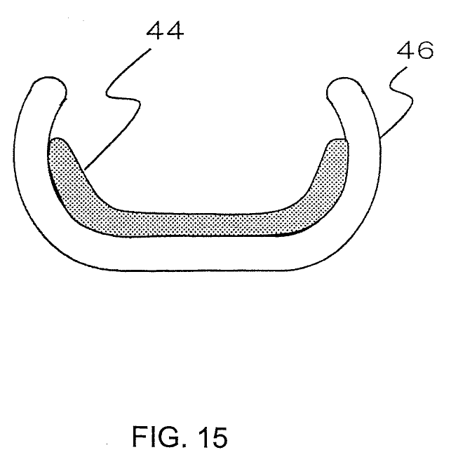

FIG. 15 is a diagram showing the cross section of the fluorescent layer support member 46 formed with the fluorescent layer 44 by way of example.

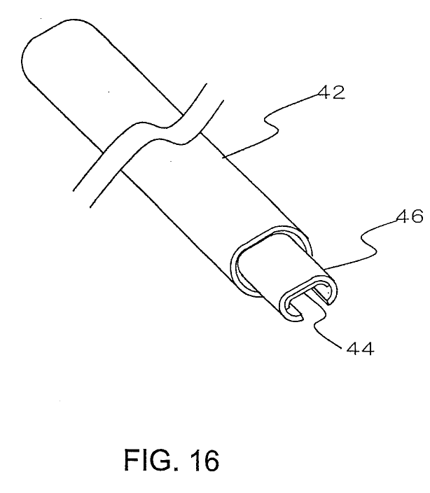

FIG. 16 is a diagram showing the step of inserting the fluorescent layer support member 46 formed with the fluorescent layer 44 shown in FIG. 15 into the minute tube 42. When the fluorescent layer support member 46, 200, 210, 220, 230, 240 or 250 formed with the fluorescent layer 44 is inserted into the minute tube 42, the fluorescent layer 44 is less liable to contact the minute tube 42, whereby the chipping and the separation of the fluorescent layer 44 are prevented. This owes to the shape of the fluorescent layer support member 46, 200, 210, 220, 230, 240, 250.

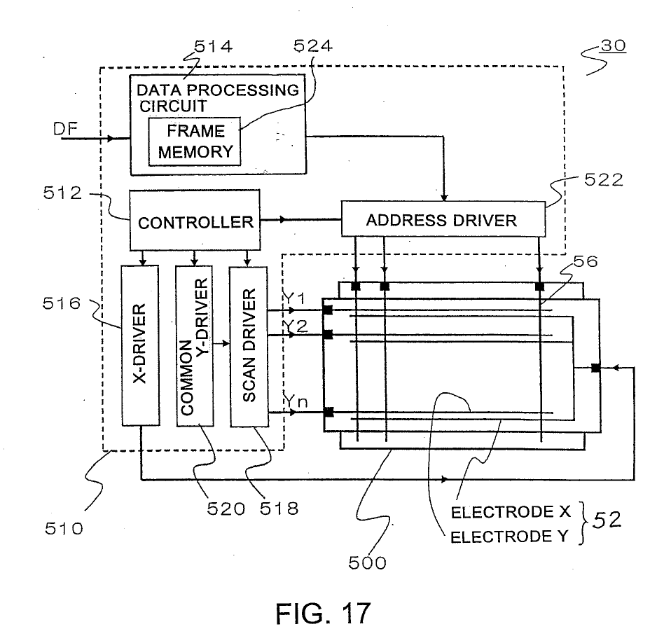

FIG. 17 is a diagram schematically showing a plasma light emitting string display device 30 employing the plasma light emitting strings 40 according to the present invention. The plasma light emitting string display device 30 includes an array 500 of the plasma light emitting strings, and a drive unit 510. In this embodiment, the display electrode pairs 52 each extend along a line of a display screen, and sustain electrodes Y of the display electrode pairs 52 serve as scanning electrodes for selecting a line of cells for addressing cells in which an electric discharge is to be caused. The address electrodes 56 each extend along a column of the display screen for selecting a column of cells. The drive unit 510 includes a controller 512, a data processing circuit 514, an X-driver 516, a scan driver 518, a common Y-driver 520, an address driver 522 and a power source circuit not shown. Pixel-based field data DF indicating a luminance level (gradation level or, in the case of full-color display, RGB luminance levels) is inputted together with synchronization signals to the drive unit 510 from an external device such as a TV tuner or a computer. The field data DF is once stored in a frame memory 524 in the data processing circuit 514, and then processed for gradation display. The processed data is stored in the frame memory 524, and transferred to the address driver 522 in proper timing.

The X-driver 516 applies a drive voltage to all the sustain electrodes X. The scan driver 518 individually applies a drive voltage to the sustain electrodes Y for addressing. The common Y-driver 520 applies a drive voltage to the respective display electrodes Y at a time for sustaining light emission.

### INDUSTRIAL APPLICABILITY

The light emitting string is produced by forming the fluorescent layer on the fluorescent layer support member having the opening and configured such as to protect the fluorescent layer, and inserting the fluorescent layer support member into the minute tube. Therefore, when the fluorescent layer support member is inserted into the minute tube, the fluorescent layer is prevented from contacting the interior wall of the minute tube. This prevents the chipping, the separation and the cracking of the fluorescent layer, thereby improving the yield in production of plasma light emitting strings.

### DESCRIPTION OF REFERENCE CHARACTERS

30: Plasma light emitting string display device
40: Plasma light emitting string
42: Minute tube
44: Fluorescent layer
46: Fluorescent layer support member
48: Discharge gas
50: Front film board
52: Sustain electrode pair
54: Rear board
56: Address electrode
100: Base material
102: Base material
200,210,220,230,240,250: Fluorescent layer support member
202,212,222,232,242: Opening

1. A plasma light emitting string comprising:
an elongated tube made of a light transmissive material;
a fluorescent layer support member formed with a fluorescent layer and disposed in the elongated tube; and
a discharge gas filled in the elongated tube;
wherein a width of an opening of the fluorescent layer support member defined between ends of an outer peripheral portion of the fluorescent layer support member as seen in a section taken perpendicularly to a length of the fluorescent layer support member is smaller than a maximum width of the outer peripheral portion of the fluorescent layer support member.

2. A plasma light emitting string as set forth in claim 1, wherein a portion of the fluorescent layer support member adjacent to the opening has a thickness that is smaller than a maximum thickness of the fluorescent layer support member.

3. A plasma light emitting string comprising:
an elongated tube made of a light transmissive material;
a fluorescent layer support member formed with a fluorescent layer and disposed in the elongated tube; and
a discharge gas filled in the elongated tube;
wherein ends of an opening of the fluorescent layer support member as seen in a section taken perpendicularly to a length of the fluorescent layer support member each have a curved bulge.

4. A plasma light emitting string as set forth in claim 3, wherein the bulges each have a generally round cross section or an elliptical cross section.

5. A light emitting string display device comprising:
a plurality of plasma light emitting strings arrayed with their openings facing in the same direction, the plasma light emitting strings each being a plasma light emitting string as recited in claim 1;
a front plate opposed to the openings of the plasma light emitting strings;
a rear plate opposed to the front plate with the intervention of the plasma light emitting strings;
a plurality of sustain electrodes provided on a surface of the front plate contacting the plasma light emitting strings as extending perpendicularly to lengths of the plasma light emitting strings; and
a plurality of address electrodes provided in association with the corresponding plasma light emitting strings on a surface of the rear plate contacting the plasma light emitting strings as extending perpendicularly to the sustain electrodes.

6. A light emitting string display device comprising:
a plurality of plasma light emitting strings arrayed with their openings facing in the same direction, the plasma light emitting strings each being a plasma light emitting string as recited in claim 2;
a front plate opposed to the openings of the plasma light emitting strings;
a rear plate opposed to the front plate with the intervention of the plasma light emitting strings;
a plurality of sustain electrodes provided on a surface of the front plate contacting the plasma light emitting strings as extending perpendicularly to lengths of the plasma light emitting strings; and
a plurality of address electrodes provided in association with the corresponding plasma light emitting strings on a surface of the rear plate contacting the plasma light emitting strings as extending perpendicularly to the sustain electrodes.

7. A light emitting string display device comprising:
a plurality of plasma light emitting strings arrayed with their openings facing in the same direction, the plasma light emitting strings each being a plasma light emitting string as recited in claim 3;
a front plate opposed to the openings of the plasma light emitting strings;
a rear plate opposed to the front plate with the intervention of the plasma light emitting strings;
a plurality of sustain electrodes provided on a surface of the front plate contacting the plasma light emitting strings as extending perpendicularly to lengths of the plasma light emitting strings; and
a plurality of address electrodes provided in association with the corresponding plasma light emitting strings on a surface of the rear plate contacting the plasma light emitting strings as extending perpendicularly to the sustain electrodes.

8. A light emitting string display device comprising:
a plurality of plasma light emitting strings arrayed with their openings facing in the same direction, the plasma light emitting strings each being a plasma light emitting string as recited in claim 4;
a front plate opposed to the openings of the plasma light emitting strings;
a rear plate opposed to the front plate with the intervention of the plasma light emitting strings;
a plurality of sustain electrodes provided on a surface of the front plate contacting the plasma light emitting strings as extending perpendicularly to lengths of the plasma light emitting strings; and
a plurality of address electrodes provided in association with the corresponding plasma light emitting strings on a surface of the rear plate contacting the plasma light emitting strings as extending perpendicularly to the sustain electrodes.
